(19) United States
(12) Patent Application Publication
(10) Pub. No.: US 2007/0260974 A1
(43) Pub. Date: Nov. 8, 2007

(54) System and method for assigning a disposition to a document through information flow knowledge

(76) Inventor: Carl H. Hauser, Mountain View, CA (US)

Correspondence Address: CASCADIA INTELLECTUAL PROPERTY, 500 UNION STREET, SUITE 1005, SEATTLE, WA, 98101, US

(21) Appl. No.: 11/827,745

(22) Filed: Jul. 13, 2007

Related U.S. Application Data
(63) Continuation of application No. 09/472,762, filed on Dec. 27, 1999, now abandoned.

(51) Int. Cl. G06F 15/00

(52) U.S. Cl. 715/513

(57) ABSTRACT

A system and method for assigning a disposition to a document through information flow knowledge is presented. Functional categories that each describe a type of document are defined. Information flow knowledge regarding a plurality of documents that each belong to different ones of the functional categories is captured. A procedure is defined for each of the functional categories including at least one disposition derived from the information flow knowledge, which is applicable to those documents belonging to the functional category. An input document is loaded from one of paper or electronic form. The input document is processed by evaluating characteristics to determine the functional category to which the input document most closely fits. Information is extracted from content contained in the input document. The procedure for the functional category of the input document to the information are applied and the disposition is related to the input document.

### CROSS-REFERENCE TO RELATED APPLICATION

This patent application is a continuation of U.S. patent application Ser. No. 09/472,762, filed Dec. 27, 1999, pending, the priority filing date of which is claimed, and the disclosure of which is incorporated by reference.

### FIELD

The present invention relates to the field of document management, and more particularly, to a system for providing document management for the organization, handling, and retention of personal documents.

### BACKGROUND

Financial documents commonly found in the home such as bills, invoices, receipts, bank and brokerage statements, and tax records tend to pile up over time and become difficult to manage effectively. The volume of paper itself becomes a storage problem, and if the person's house is destroyed in a disaster such as an earthquake or fire, the owner of the documents can lose valuable records and financial information.

Existing approaches for managing personal documents include Internet banking and bill payment web sites, spreadsheet programs, and software for organizing electronic documents. One problem with existing approaches is that they do not relate the different types of documents to each other. Existing systems also do not provide a centralized repository for storing and managing documents. Accordingly, there is a need in the art for a personal document management system that provides centralized organization, handling, and retention capabilities.

### SUMMARY

The present invention provides a document management system that provides centralized organization, handling, and retention capabilities. Documents in paper and electronic document format are loaded into the system, important information is extracted, and the documents are handled appropriately based on knowledge about the information flow between documents and the transactions that are associated with each document. Document specific handling procedures use the extracted information to relate documents to each other and to provide information about activities related to the documents, for example, bill-payment. Decisions about when to keep and when to discard documents are made in order to determine which documents should be backed up to a secondary or remote location for later retrieval. Documents that are to be kept are downloaded via the system's centralized backup capability, thus allowing a user to download documents to a location outside the home or office, allowing for retrieval if the original documents are destroyed.

One embodiment provides a system and method for applying an information flow to an input document. Information flow for a plurality of related documents that each belong to different ones of a plurality of functional categories is analyzed. Procedures for the documents in the functional categories comprising at least one disposition derived from the information flow are specified. The functional category to which an input document belongs is determined. Information is extracted from the input document. The procedure for the functional category of the input document to the information is applied to find the disposition.

A further embodiment provides a system and method for assigning a disposition to a document through information flow knowledge. Functional categories that each describe a type of document are defined. Information flow knowledge regarding a plurality of documents that each belong to different ones of the functional categories is captured. A procedure is defined for each of the functional categories including at least one disposition derived from the information flow knowledge, which is applicable to those documents belonging to the functional category. An input document is loaded from one of paper or electronic form. The input document is processed by evaluating characteristics to determine the functional category to which the input document most closely fits. Information is extracted from content contained in the input document. The procedure for the functional category of the input document to the information are applied and the disposition is related to the input document.

Still other embodiments of the invention will become readily apparent to those skilled in the art from the following detailed description, wherein is described embodiments of the invention by way of illustrating the best mode contemplated for carrying out the invention. As will be realized, the invention is capable of other and different embodiments and its several details are capable of modifications in various obvious respects, all without departing from the spirit and the scope of the invention. Accordingly, the drawings and detailed description are to be regarded as illustrative in nature and not as restrictive.

### BRIEF DESCRIPTION OF THE DRAWINGS

A more complete appreciation of the invention and many of its attendant advantages will be readily obtained and understood by referring to the following detailed description and the accompanying drawings in which like reference numerals denote like elements as between the various drawings. The drawings are briefly described below.

FIG. 1 is a block diagram illustrating a personal document management system in an embodiment of the present invention;

FIG. 2 is a flowchart illustrating steps that are performed in a method for managing personal documents in an embodiment of the present invention.

### DETAILED DESCRIPTION

An embodiment of the present invention provides a system for personal document management. The system of the present invention performs methods that may be implemented on a computer system having a computer-readable medium and may be performed using computer-executable instructions. The computer-executable instructions may be included in a computer program product. The methods may also include transferring a computer program product from one or more first computers to one or more second computers through a communications medium.

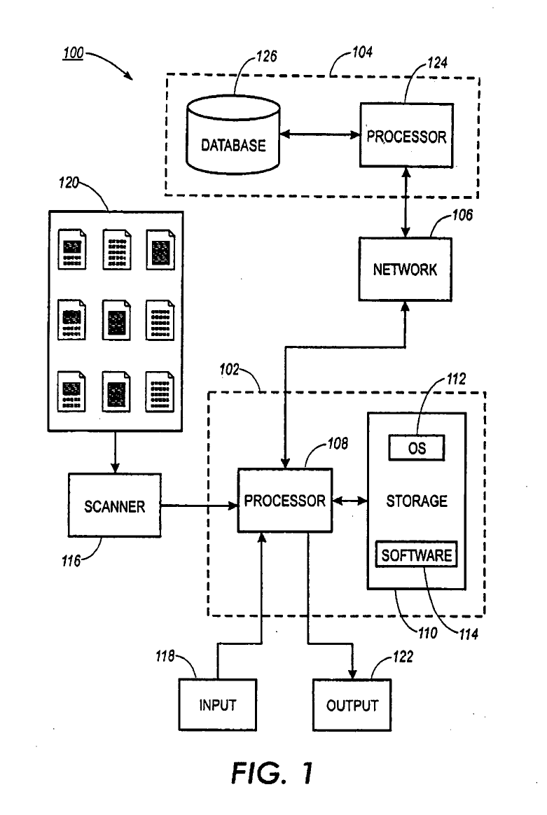

FIG. 1 is a block diagram 100 illustrating a document management system in an embodiment of the present invention. Such a document management system would be useful for personal documents or in a small office/home office (SOHO) environment. Document management system 100 includes a local computer system 102, such as a personal computer and a remote computer system 104 such as that provided by an off-site Internet service provider. Local computer system 102 and remote computer system 104 are connected to each other through a communications network 106. The local computer system 102 includes a processor 108 having local storage 110. Storage 110 includes an operating environment 112 and software 114 configured to provide document handling according to an embodiment of the present invention. Local computer system 102 also includes a scanner 116 and other input devices 118, such as a keyboard or a computer-readable medium. Paper documents 120 are input to the system via the scanner 116, which converts the documents to electronic format and loads them into the storage 110. Electronic documents (not shown) may be loaded into storage 10 without being scanned, via input 118 to processor 108. Local computer system 102 also includes an output device 122, for example a printer or a display device that is connected to processor 108.

Remote computer system 104 may be used for securely backing up documents to be retained. The documents to be retained are organized for effective use and are securely backed up to remote computer system 104 using a communications network 106, such as the Internet. Remote computer system 104 includes a processor 124 that is connected to a remote storage device 126. One reason for backing up the documents to another location such as remote computer system 104 is to provide the ability to retrieve the information contained in the documents in case any of the original documents or the documents loaded onto computer system 102 are lost or destroyed.

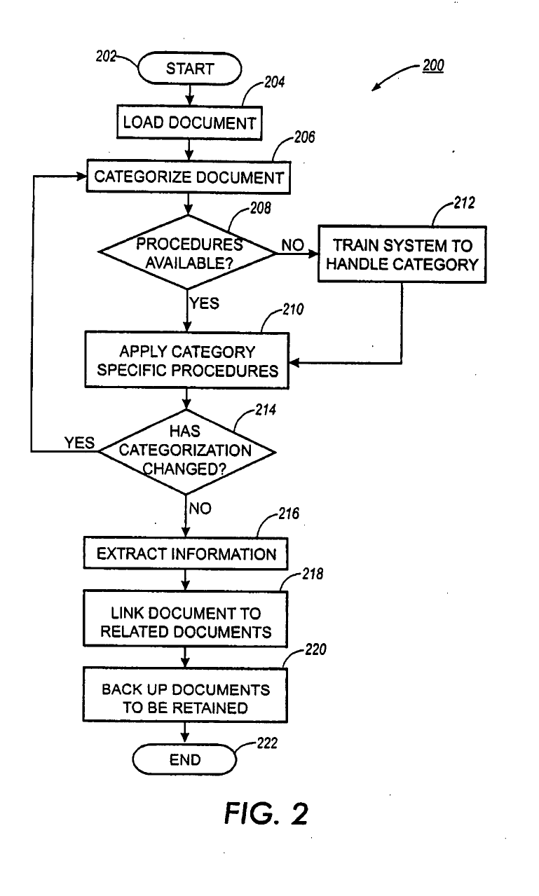

FIG. 2 is a flowchart 200 illustrating an example of steps that may be performed in a method for managing personal documents in an embodiment of the present invention. The method begins, step 202, and a document is loaded, step 204. The document may loaded by being retrieved electronically (for example, from a disk or from the Internet) or the document may be loaded by being scanned in from a paper document. The document has a format and a category associated with it, each described further below. The format indicates whether the document is in paper or electronic form. The category relates to the function of the document. For example, some document categories include bills, invoices, receipts, bank and brokerage statements, tax returns, product warranties and checks. Categories such as bills and receipts may be divided up into subcategories such as credit card, utility, mortgage, or insurance. Miscellaneous categories may also be set up, step 212 described further below, so that the user may define categories that are not already defined in the system, for example documents coming from an external source such as business trip receipts.

Once the document is loaded, step 204, the document is then characterized, step 206, to determine the document category. Categorizing a document may be done in numerous ways. The content of the document, or data items included in the document, might be used to characterize it. For example, one might search for a data item such as a bank account number to find a bank statement, or one might search for a data item such as the name of a company (such as the utility company) to find a bill. The shape of the document might be used separately or in conjunction with the document content to categorize the document. For example, long and skinny documents often are receipts such as a purchase receipt or an ATM machine receipt. Alternatively, the user could identify a pattern that may be used for categorizing the document. For example, a user could specify what a document is when it is input to the system and label the document as belonging to a particular category, such as a bill, a statement, etc. The user might also customize the system by training the system to detect additional document types. This could be done by programming the system to accept and identify additional formats (by using layout or template information), text information (such as an account number or a merchant name), or images in a document (for example a logo).

An embodiment of the present invention could optionally check to determine whether category-specific procedures are available, step 208. If the procedures are available on the system, then they could be applied to the document, step 210. If no procedures relating to the particular document category are found on the system, then a user might optionally train the system to handle a new category, step 212, by customizing the system. After training the system to deal with the category, step 212, the new procedures might then be applied to the document, step 210. If the categorization for the document has changed enough that the procedures do not apply, step 214, then the document might be re-categorized in step 206. Otherwise, processing continues to step 216, where the document information is extracted.

Category-specific document handling procedures are applied to the document in step 210. The category-specific document handling procedures embody knowledge about flows of information between the documents entered into the document handling system. Documents may be organized by category, by a time component, or by transaction. For example, organization by category might include associating credit card receipts with credit card bills and checks that are used to pay the credit card bills. An example of organization by a time component might include keeping a list of credit card statements in order by date. An example of organizing documents by transaction might include associating the warranties on purchased items with the receipts from the sale of the item and/or the credit card bill showing the purchase of the item. Checks and ATM receipts and their amounts may be associated with bank statements. One way of associating checks with bank account statements is to use the standard line at the bottom of a check that includes the account number and the amount that the check was cashed for. Trade confirmations may be associated with brokerage account statements.

Knowledge about how these documents relate to home activities such as filing tax returns, making insurance claims, and contesting bills, might also be reflected in the document handling procedures. A set of category-specific handling rules may be implemented in the document handling system by default, and may be customized to meet a particular user's needs.

Based on the document category, information is extracted from the document, step 216. The information that may be extracted from the documents include for example, account numbers, due dates, check numbers, recipient names, etc. that are associated with the input documents. This information might be extracted by using text searching techniques, image identification techniques, or by identifying the format of a particular document. For example, a credit card bill tends to have the same format from month to month. By taking advantage of the layout of the document, the relevant information such as the account number, the purchases made, and the balance may be extracted based on their usual locations in the layout of the document. A template could be set up to reflect the credit card bill format. This template could be changed when the credit card company changes the format of the bill. Credit card companies could even make their bill formats accessible via the Internet so that the user can download it into the document system so that the relevant information may be extracted accurately.

The information extracted in step 216 might be used to link the document to other related documents, step 218. Optionally, documents may be backed up and retained, step 220, after which processing ends, step 222. Using the knowledge referred to above, an embodiment of the present invention also may be used to guide a user in setting up and carrying out a retention plan for home documents. Document retention is a valuable feature because it provides the user the ability to retrieve the retained document information if the original documents are lost, stolen or destroyed. The decision to retain and backup a document, step 220 is based on the document's category, age, and other information that a user might input into the system. Document retention rules reflect the fact that documents typically lose their usefulness after a long enough period of time. For example, it is not necessary to keep tax records after approximately seven years, so a user may wish to dispose of them or not back them up to off-site storage. Also a user may wish to override and change any default document retention rules to fulfill a particular need, such as a desire to keep some documents private by not backing them up to a remote system on the Internet. In order to retrieve documents that have been backed up, the user simply accesses the remote computer system 104 and downloads them onto the local computer system 102 through the network 106.

While the embodiments of the present invention described herein have focused on personal document management featuring specific examples of financial document handling and Internet backup capability, other types of documents and backup methods could be used without departing from the spirit and scope of the present invention. Thus, it should be appreciated that the above description is merely illustrative, and should not be read to limit the scope of the invention or the claims.

What is claimed is:

1. A system for applying an information flow to an input document, comprising:
an analyzer to analyze information flow for a plurality of related documents that each belong to different ones of a plurality of functional categories;
procedures specified for the documents in the functional categories comprising at least one disposition derived from the information flow;
a document processor, comprising:
a categorization module to determine the functional category to which an input document belongs;
an extraction module to extract information from the input document; and
a disposition module to apply the procedure for the functional category of the input document to the information to find the disposition.

2. A system according to claim 1, wherein the input document is categorized by one or more of content, data items, shape, pattern, and trained characterization.

3. A system according to claim 2, further comprising:
a training module to form the trained characterization from data comprising one or more of a template, text information, and images.

4. A system according to claim 1, wherein the disposition is selected from the group comprising one or more of:
a group to link the input document to other input documents;
a local storage to retain the input document;
a file system to delete the input document;
a remote storage to back up the input document;
an organization to retaining the input document with other input documents; and
a trained disposition.

5. A system according to claim 4, wherein the input document and the other input documents are organized by one or more of the functional category to which the input document belongs, time data provided in the input document, and nature of transaction described in the input document.

6. A system according to claim 1, wherein the information extracted through one or more of:
a search module to search text in the input document;
an image analyzer to identify images in the input document; and
a layout analyzer to identify of a format of the input document.

7. A system according to claim 1, further comprising:
a trainer module to guide setup and implementation of a retention plan based on the input document and information.

8. A method for applying an information flow to an input document, comprising:
analyzing information flow for a plurality of related documents that each belong to different ones of a plurality of functional categories;
specifying procedures for the documents in the functional categories comprising at least one disposition derived from the information flow;
determining the functional category to which an input document belongs;
extracting information from the input document; and
applying the procedure for the functional category of the input document to the information to find the disposition.

9. A method according to claim 8, further comprising:
categorizing the input document by one or more of content, data items, shape, pattern, and trained characterization.

10. A method according to claim 9, further comprising:
forming the trained characterization from data comprising one or more of a template, text information, and images.

11. A method according to claim 8, wherein the disposition is selected from the group comprising one or more of:
linking the input document to other input documents;
retaining the input document;
deleting the input document;
backing up the input document;
retaining the input document through organization with other input documents; and
forming a trained disposition.

12. A method according to claim 11, further comprising:
organizing the input document and the other input documents by one or more of the functional category to which the input document belongs, time data provided in the input document, and nature of transaction described in the input document.

13. A method according to claim 8, further comprising:
determining the information extracted through one or more of:
search of text in the input document;
identification of images in the input document; and
identification of a format of the input document.

14. A method according to claim 8, further comprising:
guiding setup and implementation of a retention plan based on the input document and information.

15. A system for assigning a disposition to a document through information flow knowledge, comprising:
functional categories that each describe a type of document;
a flow analyzer to capture information flow knowledge regarding a plurality of documents that each belong to different ones of the functional categories;
a procedure library to define a procedure for each of the functional categories comprising at least one disposition derived from the information flow knowledge, which is applicable to those documents belonging to the functional category;
a document processor, comprising:
an input module to load an input document from one of paper or electronic form;
an evaluation module to process the input document by evaluating characteristics to determine the functional category to which the input document most closely fits;
an extraction module to extract information from content contained in the input document; and
an execution module to apply the procedure for the functional category of the input document to the information and relating the disposition to the input document.

16. A system according to claim 15, wherein the categories are selected from the group comprising bills, invoices, receipts, bank statements, brokerage statements, tax returns, product warranties, and checks.

17. A system according to claim 15, wherein the information is selected from the group comprising account numbers, due dates, check numbers, and recipient names.

18. A method for assigning a disposition to a document through information flow knowledge, comprising:
defining functional categories that each describe a type of document;
capturing information flow knowledge regarding a plurality of documents that each belong to different ones of the functional categories;
defining a procedure for each of the functional categories comprising at least one disposition derived from the information flow knowledge, which is applicable to those documents belonging to the functional category;
loading an input document from one of paper or electronic form;
processing the input document by evaluating characteristics to determine the functional category to which the input document most closely fits;
extracting information from content contained in the input document; and
applying the procedure for the functional category of the input document to the information and relating the disposition to the input document.

19. A method according to claim 18, wherein the categories are selected from the group comprising bills, invoices, receipts, bank statements, brokerage statements, tax returns, product warranties, and checks.

20. A method according to claim 18, wherein the information is selected from the group comprising account numbers, due dates, check numbers, and recipient names.
